(19) United States
(12) Patent Application Publication
(10) Pub. No.: US 2017/0109842 A1
(43) Pub. Date: Apr. 20, 2017

(54) SYSTEM AND METHOD FOR REPURPOSING UNSOLD PRODUCTS IN STORES

(71) Applicant: International Business Machines Corporation, Armonk, NY (US)

(72) Inventors: Donna K. Byron, Petersham, MA (US); Carmine Dimascio, West Roxbury, MA (US); Florian Pinel, New York, NY (US)

(21) Appl. No.: 14/887,752

(22) Filed: Oct. 20, 2015

(51) Int. Cl. G06Q 50/12; G06Q 10/08

(52) U.S. Cl. CPC G06Q 50/12; G06Q 10/087

(57) ABSTRACT

A method, computer program product, and computer system for identifying, by a computing device, that a product of a plurality of products has a likelihood of being wasted. A recipe of a plurality of recipes that includes the product may be identified. One or more attributes of the recipe may be scored. A rating may be assigned to the recipe based upon, at least in part, the one or more attributes of the recipe. The recipe may be returned as a suggestion to use the product before the product is wasted based upon, at least in part, the rating assigned to the recipe.

### BACKGROUND

Some products (e.g., food) may have an expiration date. For example, some foods may have an expiration date, after which the food may “go bad” or become spoiled. As such, the expired food may be wasted and not consumed. A large amount of the food produced globally may be wasted. For instance, part of this waste may come from grocery stores (or the like) having to throw away expired food. While some products may be donated to food banks before their expiration to limit food waste, a noticeable amount of soon to be expiring food may still end up being wasted.

### SUMMARY

In one example implementation, a method, performed by one or more computing devices, may include but is not limited to identifying, by a computing device, that a product of a plurality of products has a likelihood of being wasted. A recipe of a plurality of recipes that includes the product may be identified. One or more attributes of the recipe may be scored. A rating may be assigned to the recipe based upon, at least in part, the one or more attributes of the recipe. The recipe may be returned as a suggestion to use the product before the product is wasted based upon, at least in part, the rating assigned to the recipe.

One or more of the following example features may be included. Identifying that the product has the likelihood of being wasted may include analyzing an inventory listing the product as an available product, an expiration date of the product, and sales data associated with the product. A product salvage scorer may be used to score at least one of the one or more attributes. A shelf life scorer may be used to score at least one of the one or more attributes. A score from the shelf life scorer may be based upon, at least in part, ingredient-cooking verb pairs associated with the recipe. A score from the shelf life scorer may be based upon, at least in part, machine learning algorithm trained on a corpus of recipes labeled with shelf life scores. A demand scorer may be used to score at least one of the one or more attributes.

In another example implementation, a computing system includes a processor and a memory configured to perform operations that may include but are not limited to identifying that a product of a plurality of products has a likelihood of being wasted. A recipe of a plurality of recipes that includes the product may be identified. One or more attributes of the recipe may be scored. A rating may be assigned to the recipe based upon, at least in part, the one or more attributes of the recipe. The recipe may be returned as a suggestion to use the product before the product is wasted based upon, at least in part, the rating assigned to the recipe.

One or more of the following example features may be included. Identifying that the product has the likelihood of being wasted may include analyzing an inventory listing the product as an available product, an expiration date of the product, and sales data associated with the product. A product salvage scorer may be used to score at least one of the one or more attributes. A shelf life scorer may be used to score at least one of the one or more attributes. A score from the shelf life scorer may be based upon, at least in part, ingredient-cooking verb pairs associated with the recipe. A score from the shelf life scorer may be based upon, at least in part, machine learning algorithm trained on a corpus of recipes labeled with shelf life scores. A demand scorer may be used to score at least one of the one or more attributes.

In another example implementation, a computer program product resides on a computer readable storage medium that has a plurality of instructions stored on it. When executed by a processor, the instructions cause the processor to perform operations that may include but are not limited to identifying that a product of a plurality of products has a likelihood of being wasted. A recipe of a plurality of recipes that includes the product may be identified. One or more attributes of the recipe may be scored. A rating may be assigned to the recipe based upon, at least in part, the one or more attributes of the recipe. The recipe may be returned as a suggestion to use the product before the product is wasted based upon, at least in part, the rating assigned to the recipe.

One or more of the following example features may be included. Identifying that the product has the likelihood of being wasted may include analyzing an inventory listing the product as an available product, an expiration date of the product, and sales data associated with the product. A product salvage scorer may be used to score at least one of the one or more attributes. A shelf life scorer may be used to score at least one of the one or more attributes. A score from the shelf life scorer may be based upon, at least in part, ingredient-cooking verb pairs associated with the recipe. A score from the shelf life scorer may be based upon, at least in part, machine learning algorithm trained on a corpus of recipes labeled with shelf life scores. A demand scorer may be used to score at least one of the one or more attributes.

The details of one or more example implementations are set forth in the accompanying drawings and the description below. Other possible example features and/or possible example advantages will become apparent from the description, the drawings, and the claims. Some implementations may not have those possible example features and/or possible example advantages, and such possible example features and/or possible example advantages may not necessarily be required of some implementations.

### BRIEF DESCRIPTION OF THE DRAWINGS

FIG. 1 is an example diagrammatic view of a waste reduction (WR) process coupled to a distributed computing network according to one or more example implementations of the disclosure;

FIG. 2 is an example diagrammatic view of a client electronic device of FIG. 1 according to one or more example implementations of the disclosure;

FIG. 3 is an example flowchart of the WR process of FIG. 1 according to one or more example implementations of the disclosure; and

FIG. 4 is an example diagrammatic view of a screen image displayed by the WR process of FIG. 1 according to one or more example implementations of the disclosure.

Like reference symbols in the various drawings indicate like elements.

### DETAILED DESCRIPTION

System Overview:

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

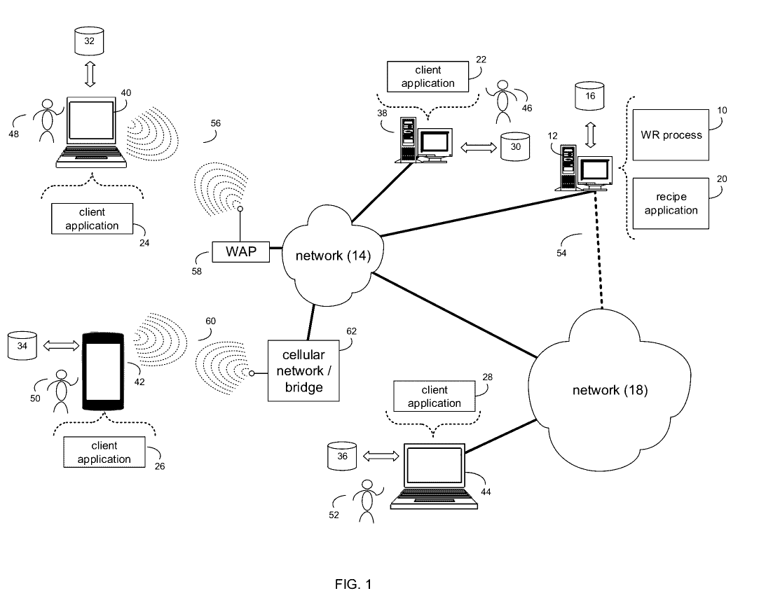

Referring now to FIG. 1, there is shown waste reduction (WR) process 10 that may reside on and may be executed by a computer (e.g., computer 12), which may be connected to a network (e.g., network 14) (e.g., the internet or a local area network). Examples of computer 12 (and/or one or more of the client electronic devices noted below) may include, but are not limited to, a personal computer(s), a laptop computer(s), mobile computing device(s), a server computer, a series of server computers, a mainframe computer(s), or a computing cloud(s). Computer 12 may execute an operating system, for example, but not limited to, Microsoft® Windows® Mac® OS X®; Red Hat® Linux®, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

As will be discussed below in greater detail, WR process 10 may identify, by a computing device, that a product of a plurality of products has a likelihood of being wasted. A recipe of a plurality of recipes that includes the product may be identified. One or more attributes of the recipe may be scored. A rating may be assigned to the recipe based upon, at least in part, the one or more attributes of the recipe. The recipe may be returned as a suggestion to use the product before the product is wasted based upon, at least in part, the rating assigned to the recipe.

The instruction sets and subroutines of WR process 10, which may be stored on storage device 16 coupled to computer 12, may be executed by one or more processors (not shown) and one or more memory architectures (not shown) included within computer 12. Storage device 16 may include but is not limited to: a hard disk drive; a flash drive, a tape drive; an optical drive; a RAID array; a random access memory (RAM); and a read-only memory (ROM).

Network 14 may be connected to one or more secondary networks (e.g., network 18), examples of which may include but are not limited to: a local area network; a wide area network; or an intranet, for example.

Computer 12 may include a data store, such as a database (e.g., relational database, object-oriented database, triplestore database, etc.) and may be located within any suitable memory location, such as storage device 16 coupled to computer 12. Any data, metadata, information, etc. described throughout the present disclosure may be stored in the data store. In some implementations, computer 12 may utilize any known database management system such as, but not limited to, DB2, in order to provide multi-user access to one or more databases, such as the above noted relational database. The data store may also be a custom database, such as, for example, a flat file database or an XML database. Any other form(s) of a data storage structure and/or organization may also be used. WR process 10 may be a component of the data store, a standalone application that interfaces with the above noted data store and/or an applet/application that is accessed via client applications 22, 24, 26, 28. The above noted data store may be, in whole or in part, distributed in a cloud computing topology. In this way, computer 12 and storage device 16 may refer to multiple devices, which may also be distributed throughout the network.

Computer 12 may execute a recipe application, such as (e.g., recipe application 20), examples of which may include, but are not limited to, the IBM Watson™ application or other Question Answering (QA) application, the IBM Chef Watson™ application or other recipe generation application, a recipe search application, a recipe catalog application, a search engine application, a natural language processing (NLP) application, or other application that allows for the calculation of features for recipe selection. One or more aspects of IBM Chef Watson™ may be described, at least in part, for example, in “AUTOMATED GENERATION OF NEW WORK PRODUCTS AND WORK PLANS”, U.S. patent application Ser. No. 13/847,099 by Pinel et al., filed on 19 Mar. 2013, and “A Big Data Approach to Computational Creativity” by LR Varshney et al., arXiv:1311.1213v1 [cs.CY], 5 Nov. 2013, the contents of which are hereby incorporated by reference in their entirety. WR process 10 and/or recipe application 20 may be accessed via client applications 22, 24, 26, 28. WR process 10 may be a stand alone application, or may be an applet/application/script/extension that may interact with and/or be executed within recipe application 20, a component of recipe application 20, and/or one or more of client applications 22, 24, 26, 28. Recipe application 20 may be a stand alone application, or may be an applet/application/script/extension that may interact with and/or be executed within WR process 10, a component of WR process 10, and/or one or more of client applications 22, 24, 26, 28. One or more of client applications 22, 24, 26, 28 may be a stand alone application, or may be an applet/application/script/extension that may interact with and/or be executed within and/or be a component of WR process 10 and/or recipe application 20. Examples of client applications 22, 24, 26, 28 may include, but are not limited to, the IBM Watson™ application or other Question Answering (QA) application, the IBM Chef Watson™ application or other recipe generation application, a recipe search application, a recipe catalog application, a search engine application, a natural language processing (NLP) application, or other application that allows for the calculation of features for recipe selection, a standard and/or mobile web browser, an email client application, a textual and/or a graphical user interface, a customized web browser, a plugin, an Application Programming Interface (API), or a custom application. The instruction sets and subroutines of client applications 22, 24, 26, 28, which may be stored on storage devices 30, 32, 34, 36, coupled to client electronic devices 38, 40, 42, 44, may be executed by one or more processors (not shown) and one or more memory architectures (not shown) incorporated into client electronic devices 38, 40, 42, 44.

Storage devices 30, 32, 34, 36, may include but are not limited to: hard disk drives; flash drives, tape drives; optical drives; RAID arrays; random access memories (RAM); and read-only memories (ROM). Examples of client electronic devices 38, 40, 42, 44 (and/or computer 12) may include, but are not limited to, a personal computer (e.g., client electronic device 38), a laptop computer (e.g., client electronic device 40), a smart/data-enabled, cellular phone (e.g., client electronic device 42), a notebook computer (e.g., client electronic device 44), a tablet (not shown), a server (not shown), a television (not shown), a smart television (not shown), a media (e.g., video, photo, etc.) capturing device (not shown), and a dedicated network device (not shown). Client electronic devices 38, 40, 42, 44 may each execute an operating system, examples of which may include but are not limited to, Android™, Apple® iOS®, Mac® OS X®; Red Hat® Linux®, or a custom operating system.

One or more of client applications 22, 24, 26, 28 may be configured to effectuate some or all of the functionality of WR process 10 (and vice versa). Accordingly, WR process 10 may be a purely server-side application, a purely client-side application, or a hybrid server-side/client-side application that is cooperatively executed by one or more of client applications 22, 24, 26, 28 and/or WR process 10.

One or more of client applications 22, 24, 26, 28 may be configured to effectuate some or all of the functionality of recipe application 20 (and vice versa). Accordingly, recipe application 20 may be a purely server-side application, a purely client-side application, or a hybrid server-side/client-side application that is cooperatively executed by one or more of client applications 22, 24, 26, 28 and/or recipe application 20. As one or more of client applications 22, 24, 26, 28, WR process 10, and recipe application 20, taken singly or in any combination, may effectuate some or all of the same functionality, any description of effectuating such functionality via one or more of client applications 22, 24, 26, 28, WR process 10, recipe application 20, or combination thereof, and any described interaction(s) between one or more of client applications 22, 24, 26, 28, WR process 10, recipe application 20, or combination thereof to effectuate such functionality, should be taken as an example only and not to limit the scope of the disclosure.

Users 46, 48, 50, 52 may access computer 12 and WR process 10 (e.g., using one or more of client electronic devices 38, 40, 42, 44) directly through network 14 or through secondary network 18. Further, computer 12 may be connected to network 14 through secondary network 18, as illustrated with phantom link line 54. WR process 10 may include one or more user interfaces, such as browsers and textual or graphical user interfaces, through which users 46, 48, 50, 52 may access WR process 10.

The various client electronic devices may be directly or indirectly coupled to network 14 (or network 18). For example, client electronic device 38 is shown directly coupled to network 14 via a hardwired network connection. Further, client electronic device 44 is shown directly coupled to network 18 via a hardwired network connection. Client electronic device 40 is shown wirelessly coupled to network 14 via wireless communication channel 56 established between client electronic device 40 and wireless access point (i.e., WAP) 58, which is shown directly coupled to network 14. WAP 58 may be, for example, an IEEE 802.11a, 802.11b, 802.11g, Wi-Fi®, and/or Bluetooth™ (including Bluetooth™ Low Energy) device that is capable of establishing wireless communication channel 56 between client electronic device 40 and WAP 58. Client electronic device 42 is shown wirelessly coupled to network 14 via wireless communication channel 60 established between client electronic device 42 and cellular network/bridge 62, which is shown directly coupled to network 14.

Some or all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. Bluetooth™ (including Bluetooth™ Low Energy) is a telecommunications industry specification that allows, e.g., mobile phones, computers, smart phones, and other electronic devices to be interconnected using a short-range wireless connection. Other forms of interconnection (e.g., Near Field Communication (NFC)) may also be used.

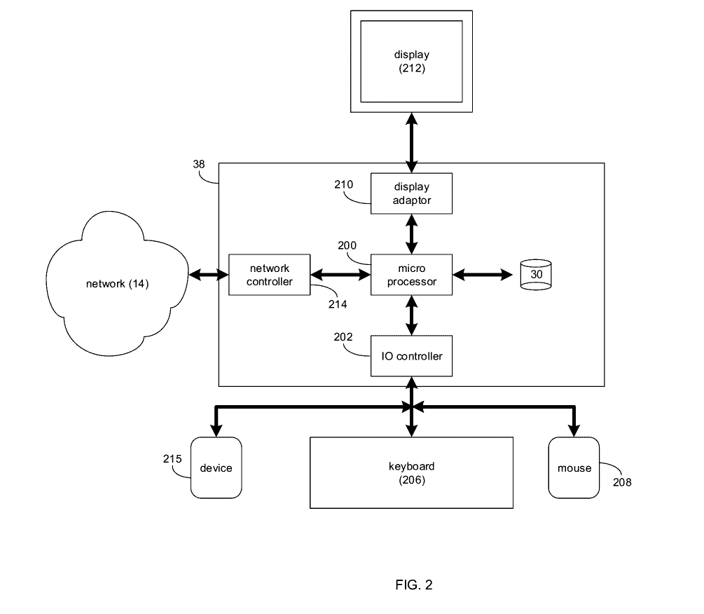

Referring also to FIG. 2, there is shown a diagrammatic view of client electronic device 38. While client electronic device 38 is shown in this figure, this is for illustrative purposes only and is not intended to be a limitation of this disclosure, as other configurations are possible. For example, any computing device capable of executing, in whole or in part, WR process 10 may be substituted for client electronic device 38 within FIG. 2, examples of which may include but are not limited to computer 12 and/or client electronic devices 40, 42, 44.

Client electronic device 38 may include a processor and/or a microprocessor (e.g., microprocessor 200) configured to, for example, process data and execute the above-noted code/instruction sets and subroutines. Microprocessor 200 may be coupled via a storage adaptor (not shown) to the above-noted storage device(s) (e.g., storage device 30). An I/O controller (e.g., I/O controller 202) may be configured to couple microprocessor 200 with various devices, such as keyboard 206, pointing/selecting device (e.g., touchpad, touchscreen, mouse 208, etc.), custom device (e.g., device 215), USB ports (not shown), and printer ports (not shown). A display adaptor (e.g., display adaptor 210) may be configured to couple display 212 (e.g., touchscreen monitor(s), plasma, CRT, or LCD monitor(s), etc.) with microprocessor 200, while network controller/adaptor 214 (e.g., an Ethernet adaptor) may be configured to couple microprocessor 200 to the above-noted network 14 (e.g., the Internet or a local area network).

Question Answering (QA) systems, such as the IBM Watson™ system, may include an application of advanced natural language processing, information retrieval, knowledge representation and reasoning, and machine learning technologies to the field of open domain question answering. The IBM Watson™ system may be built on IBM's DeepQA technology (or other compatible technology) used for hypothesis generation, massive evidence gathering, analysis, and scoring. The IBM Watson™ system may take an input question, analyze it, decompose the question into constituent parts, generate one or more hypothesis based on the decomposed question and results of a primary search of answer sources, perform hypothesis and evidence scoring based on a retrieval of evidence from evidence sources, perform synthesis of the one or more hypothesis, and based on trained models, perform a final merging and ranking to output an answer to the input question along with a confidence measure.

In some implementations, recipe application 20, which may include the above-noted IBM Chef Watson™ system, may include, e.g., an application of advanced natural language processing, information retrieval, knowledge representation and reasoning, and machine learning technologies to the field of recipe generation. Recipe application 20 may be built on IBM's DeepQA technology (or other compatible technology) used for hypothesis generation, massive evidence gathering, analysis, and scoring. As will be discussed below, recipe application 20 may take an input consisting of one or more ingredients, dish types, and/or cooking styles, analyze it, generate one or more recipes based on a primary search of a recipe corpus, perform scoring based on a retrieval of evidence from evidence sources, and perform a final merging and ranking to output an answer to the input criteria along with a score. Recipe application 20 may include a recipe search engine, a recipe aggregator, or any searchable collection of recipes, recipe ideas or ingredient combinations.

As noted above, some products (e.g., food) may have an expiration date. For example, some foods may have an expiration date, after which the food may “go bad” or become spoiled. As such, the expired food may be wasted and not consumed. A large amount of the food produced globally may be wasted. For instance, part of this waste may come from grocery stores (or the like) having to throw away expired food. While some products may be donated to food banks before their expiration to limit food waste, a noticeable amount of soon to be expiring food may still end up being wasted. Additionally, while some products may be repurposed (e.g., used in a recipe and sold as prepared food) to limit food waste, merely identifying a recipe that uses a soon to be expiring product may not efficiently limit food waste. For example, if a recipe that uses a soon to be expiring product is selected to be made into a prepared food for sale, the soon to be expiring product may still go to waste if there is no customer demand for the prepared food. As will be discussed in greater detail below, WR process 10 may consider one or more aspects of a particular recipe (e.g., amount of soon to be expiring products used in the recipe, shelf life of the recipe, customer demand for the recipe, etc.) that may use a soon to be expired product to better ensure the product is not wasted.

The WR Process:

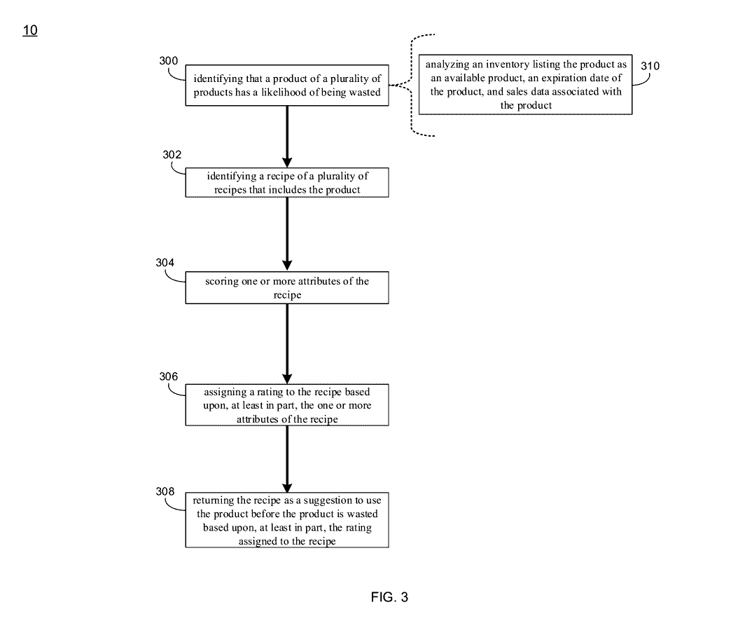

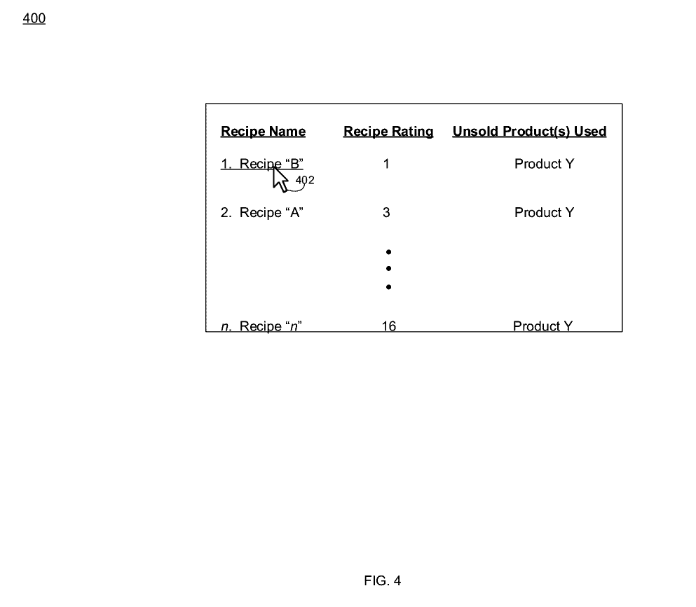

As discussed above and referring also at least to FIGS. 3-4, waste reduction (WR) process 10 may identify 300, by a computing device, that a product of a plurality of products has a likelihood of being wasted. WR process 10 may identify 302 a recipe of a plurality of recipes that includes the product. WR process 10 may score 304 one or more attributes of the recipe. WR process 10 may assign 306 a rating to the recipe based upon, at least in part, the one or more attributes of the recipe. WR process 10 may return 308 the recipe as a suggestion to use the product before the product is wasted based upon, at least in part, the rating assigned to the recipe.

In some implementations, WR process 10 may identify 300, by a computing device, that a product of a plurality of products has a likelihood of being wasted. In some implementations, identifying 300 that the product has the likelihood of being wasted may include analyzing 310 an inventory listing the product as an available product, an expiration date of the product, and sales data associated with the product. For instance, assume for example purposes only that inventory data of unsold products (e.g., food) for a particular grocery store company (e.g., Company K) is stored in, e.g., the above-noted data store. In some implementations, the inventory data may include, e.g., historic sales data. In some implementations, to ensure the inventory data is up to date, the collection of the inventory data may be automated using known techniques, and/or live data may be manually supplied via WR process 10.

In the example, WR process 10 may access and/or analyze 310 this inventory data to identify which products may be in abundance (e.g., overstocked), have not sold as expected, etc. For instance, further assume in the example that by analyzing 310 the historic sales data, WR process 10 determines that an amount “X” of a product (e.g., Product Y) is typically sold during, e.g., an average time period (e.g., day, week, month, year, etc.). In the example, using an average time period of a week, further assume that by analyzing the inventory data, WR process 10 determines that an amount less than “X” of Product Y has been sold in a week, resulting in an amount “U” of unsold Product Y that exists in inventory. Thus, in the example, WR process 10 may identify 300 Product Y (or an amount “U” of Product Y) that may have a likelihood of being wasted (e.g., expiring before being sold to a customer of Company K, being overstocked, etc.).

It will be appreciated that WR process may use other models to identify 300 that Product Y may have a likelihood of being wasted without departing from the scope of the disclosure. For instance, the model may incorporate such product details as, e.g., expiration date of Product Y, which may be included in the above-noted inventory data. For example, if the amount “U” of unsold Product Y has an expiration date that is two weeks away, this may indicate (e.g., when/if compared to historic sales data of Product Y over a two week time period) a lesser likelihood that the amount “U” of Product Y will be wasted, compared to an example where the amount “U” of unsold Product Y has an expiration date that is one week away. In some implementations, the likelihood that Product Y will be wasted may be identified 300 by WR process 10 using known sales forecast models. In some implementations, products without an explicit expiration date may be assigned an average shelf life. As another example, in some implementations, the amount “U” of Product Y may be split into different groups depending on expiration date. For instance, a first portion of the amount “U” of Product Y may have a first expiration date, and a second portion of the amount “U” of Product Y may have a second (e.g., later) expiration date. Thus, in the example, the above-noted identification 300 and analysis 310 may apply to all Product Y (or all the amount “U” of Product Y) as a whole, and/or separately to portions of Product Y (or portions of the amount “U” of Product Y) based upon expiration date groupings of each portion. As such, any specific models disclosed to identify 300 and analyze 310 whether Product Y may have a likelihood of being wasted should be taken as example only and not to limit the scope of the disclosure.

In some implementations, WR process 10 may identify 302 a recipe of a plurality of recipes that includes the product. For instance, WR process 10 may help to mitigate food waste by identifying and recommending recipes that may optimize the use of overstocked or soon to expire/perish products. In some implementations, these recipes may then be used by Company K to make, e.g., “prepared foods” to pro-actively move products that may likely become waste. For example, WR process may be associated with, e.g., a recipe search engine, or a recipe generation system like the above-noted IBM Chef Watson™ application, which may identify 302 one or more recipes that may use one or more of the products (such as Product Y).

In some implementations, WR process 10 may score 304 one or more attributes of the recipe. For instance, WR process 10 may determine and assign a score to particular attributes of the recipe. In some implementations, WR process 10 may be associated with one or more “scorers”, which may score 304 one or more of the recipe attributes to evaluate the suitability of the recipe to repurpose (use) the product(s) that may have a likelihood of being wasted. As will be discussed in greater detail below, example attributes of the recipe may generally include, for instance, product salvagability denoting the quantity (e.g., per service size in the recipe) of the product used in the identified 302 recipe, shelf life of the recipe's end product, product demand for the recipe's end product, as well as other attributes.

In some implementations, a product salvage scorer may be used to score 304 at least one of the one or more attributes. For instance, WR process 10 may include a product salvage scorer, which may assign scores based upon, at least in part, the quantity (e.g., per serving size in the recipe) used for the products identified 300 as having a likelihood of being wasted (e.g., based upon the above-noted sales history, compared to current inventory by expiration date) and quantity. For instance, assume for example purposes only that an identified 302 recipe (e.g., Recipe “B”) would use a larger amount of Product Y per serving than another identified 302 recipe (e.g., Recipe “A”). In the example, the product salvage scorer of WR process 10 may score 304 the salvagability of Recipe “B” higher than the salvagability of Recipe “A”, as the identified 302 Recipe “B” would use a larger amount of Product Y per serving than identified 302 Recipe “A”.

In some implementations, the salvagability score may be based upon, at least in part, a number of different types of identified products identified 300 as having a likelihood of being wasted used in the recipe (e.g., per serving size in the recipe). For instance, assume for example purposes only that an identified 302 recipe (e.g., Recipe “B”) would use two different types of identified 300 products per serving, whereas another identified 302 recipe (e.g., Recipe “A”) only uses one identified 300 product. In the example, the product salvage scorer of WR process 10 may score 304 the salvagability of Recipe “B” higher than the salvagability of Recipe “A”, as the identified 302 Recipe “B” would use a greater number of identified 300 products per serving than identified 302 Recipe “A”. In some implementations, when more than one product is being salvaged, WR process 10 may use the cost of each product to assign weights to each product, which may contribute to the final score 304.

In some implementations, a shelf life scorer may be used to score 304 at least one of the one or more attributes. In some implementations, having a longer shelf life may increase the amount of time for a consumer to purchase the end result of the recipe, which may limit the amount of the identified 300 product that may be wasted compared to a situation where the identified 300 ingredient were not included in the recipe. For instance, WR process 10 may include a shelf life scorer, which may assign scores based upon, at least in part, the shelf life of the identified 302 recipe (e.g., amount of time for which the recipe using the product remains fit for consumption). For instance, assume for example purposes only that an identified 302 recipe (e.g., Recipe “B”) would have a longer shelf life than another identified 302 recipe (e.g., Recipe “A”). In the example, the shelf life scorer of WR process 10 may score 304 the shelf life of Recipe “B” higher than the shelf life of Recipe “A”, as the identified 302 Recipe “B” may remain fit for consumption longer than the shelf life of identified 302 Recipe “A”.

In some implementations, WR process 10 may score 304 the shelf life based upon, e.g., NLP. For instance, WR process 10 may use NLP (or other known techniques) to identify the ingredients in the identified 302 recipe. For example, the presence of certain ingredients (e.g., sugar, acid, alcohol, etc.) in the identified 302 recipe may have properties that may actually extend the shelf life of the recipe as a whole. For instance, assume for example purposes only that an identified 302 recipe (e.g., Recipe “B”) would use sugar as an ingredient, whereas another identified 302 recipe (e.g., Recipe “A”) does not use sugar as an ingredient. In the example, the shelf life scorer of WR process 10 may score 304 the shelf life of Recipe “B” higher than the shelf life of Recipe “A”, as the identified 302 Recipe “B” (based upon the use of sugar) may remain fit for consumption longer than the shelf life of identified 302 Recipe “A”.

It will be appreciated that each of the above-noted ingredients may have a different effect on the shelf life of the recipe. For instance, assume for example purposes only that while sugar and alcohol both may extend the shelf life of a recipe, sugar may extend the shelf life more than alcohol. Further assume that an identified 302 recipe (e.g., Recipe “B”) would use sugar as an ingredient, whereas another identified 302 recipe (e.g., Recipe “A”) would use alcohol as an ingredient. In the example, even though both recipes use an ingredient that may extend the shelf life of the respective recipe, the shelf life scorer of WR process 10 may score 304 the shelf life of Recipe “B” higher than the shelf life of Recipe “A”, as the identified 302 Recipe “B” (based upon the use of sugar) may remain fit for consumption longer than the shelf life of identified 302 Recipe “A” (based upon the use of alcohol). Other combinations of ingredients affecting (e.g., increasing and/or decreasing) shelf life scores may be used without departing from the scope of the disclosure. For example, recipes that may use ingredients that decrease the shelf life of a recipe (e.g., dairy products) may also be considered by WR process 10 when scoring 304 the shelf life of the recipe.

In some implementations, a score from the shelf life scorer may be based upon, at least in part, ingredient-cooking verb pairs associated with the recipe. For example, WR process 10 may score 304 the shelf life of the identified 302 recipe based upon, e.g., identifying the chain of actions applied to each ingredient in the recipe (e.g., ingredient-cooking verb pairs). For example, the presence of certain cooking instructions (e.g., “cook meat at a temperature of 400 degrees for 10 minutes”) in the identified 302 recipe may have properties that may actually extend the shelf life of the recipe as a whole. For instance, assume for example purposes only that an identified 302 recipe (e.g., Recipe “B”) has instructions to “cook meat at a temperature of 400 degrees for 10 minutes”, whereas another identified 302 recipe (e.g., Recipe “A”) has instructions to “place herbs into a bowl”. In the example, cooking a meat may extend its shelf life (and thus the shelf life of Recipe “B”), whereas Recipe “B” has dried herbs that may not need to be cooked. In the example, the shelf life scorer of WR process 10 may score 304 the shelf life of Recipe “B” higher than the shelf life of Recipe “A”, as the identified 302 Recipe “B” (based upon the ingredient-cooking verb pairs in the instructions) may remain fit for consumption longer than the shelf life of identified 302 Recipe “A”. In some implementations, cooking temperature and duration may be factored into the shelf life score, which may also have an effect on shelf life. In some implementations, WR process 10 may group ingredients and ingredient-cooking verbs into categories using ontology. For example, ingredient categories may include, e.g.,: meat, fish, shellfish, vegetables; cooking verb categories may include, e.g.,: cut (which may include chop, dice, slice, etc.), cook (which may include boil, sauté, grill, etc.), as well as other example categories. In the example, the rules may be written by WR process 10 at the category level, e.g.,: “cooked meat” may have an extended shelf life of five days”, “cutting vegetables may decrease their shelf life by one day if they are not cooked”, etc. In the example, WR process 10 may then map the recipe steps to those broader rules.

In some implementations, a score from the shelf life scorer may be based upon, at least in part, machine learning algorithm trained on a corpus of recipes labeled with shelf life scores. For example, WR process 10 may score 304 the shelf life based upon, e.g., predicting the shelf life using machine learning. For instance, WR process 10 may use a machine learning algorithm (e.g., support vector machines) to train on a corpus of recipes labeled with shelf life scores (e.g., Recipe “D” and Recipe “E” as well as a plurality of other recipes). In some implementations, the corpus may be obtained from prepared food manufacturers stored in the above-noted data store, and/or may be obtained elsewhere (e.g., the Internet). For instance, assume for example purposes only that an identified 302 recipe (e.g., Recipe “E”) is identified in the corpus as having a longer shelf life than another identified 302 recipe (e.g., Recipe “D”) identified in the corpus (or other location). In the example, the shelf life scorer of WR process 10 may compute features for another recipe (e.g., Recipe “A” and/or Recipe “B”, apply the model resulting from training on Recipe “D” and Recipe “E” (as well as a plurality of other recipes), and score 304 the shelf life of Recipe “B” higher than the shelf life of Recipe “A”, as the identified 302 Recipe “B” (according to the machine learning algorithm used by WR process 10 to train on the corpus of recipes labeled with shelf life scores) may remain fit for consumption longer than the shelf life of identified 302 Recipe “A”.

In some implementations, a demand scorer may be used to score 304 at least one of the one or more attributes. For instance, WR process 10 may include a demand scorer, which may assign scores based upon, at least in part, the customer demand for the recipe's end product. For instance, WR process 10 may include a demand scorer, which may assign scores based upon, at least in part, the customer demand for the identified 302 recipe's end product. For instance, assume for example purposes only that an identified 302 recipe (e.g., Recipe “B”) would have a higher customer demand than another identified 302 recipe (e.g., Recipe “A”). In the example, the demand scorer of WR process 10 may score 304 the demand of Recipe “B” higher than the demand of Recipe “A”, as the identified 302 Recipe “B” may have more customer demand than the customer demand of identified 302 Recipe “A”.

In some implementations, WR process 10 may use, e.g., the above-noted historic sales data per recipe (e.g., from a prepared food department of Company K or other location) to estimate demand for a given recipe, and may compare that demand to the amount of the recipe that may be made using the above-noted identified 300 Product Y (or the unsold amount “U” of Product Y) that may have a likelihood of being wasted. In the example, having a higher demand for a recipe's end result may increase the chances for a consumer to purchase the end result of the recipe, which may limit the amount of the identified 300 product that may be wasted compared to a situation where the identified 300 ingredient were not included in the recipe. For instance, assume for example purposes only that an identified 302 recipe (e.g., Recipe “B”) has a larger customer demand (e.g., higher instances of customer sales) than another identified 302 recipe (e.g., Recipe “A”). In the example, the demand scorer of WR process 10 may score 304 the demand of Recipe “B” higher than the demand of Recipe “A”, as the identified 302 Recipe “B” may sell better faster (e.g., per serving) than identified 302 Recipe “A”. In the example, having a higher demand score may be indicative of an increase in the chance for a consumer to purchase the end result of Recipe “B”, which may limit the amount of the identified 300 product that may be wasted compared to a situation where the identified 300 ingredient were instead used in Recipe “A”.

In some implementations, WR process 10 may assign 306 a rating to the recipe based upon, at least in part, the one or more attributes of the recipe. For example, based upon a combination of the above-noted scores assigned to one or more recipe attributes by the scorers, WR process 10 may assign 306 a rating to identified 302 recipe(s). For instance, an example rating assigned 306 to identified 302 recipe(s) may be generated by WR process 10 from a formula, such as, e.g., salvage score+demand score+shelf life score=rating. In some implementations, each score may be weighted differently to determine and assign 306 the rating. For instance, as another example formula, ((a)×salvage score)+((b)×demand score)+((c)×shelf life score)=rating, where (a), (b), and (c) may be selected by WR process 10 using a machine learning algorithm (assuming sufficient data exists upon which to train).

In some implementations, WR process 10 may return 308 the recipe as a suggestion to use the product before the product is wasted based upon, at least in part, the rating assigned 306 to the recipe. For example, and referring at least to FIG. 4, an example user interface (e.g., user interface 400) associated with WR process 10 is shown. In the example, WR process 10 may transmit a list (or other configuration) of the various identified 302 recipes. User interface 400 may include, e.g., the name of the recipe, the rating of the recipe, the product(s) used in the recipe, as well as other attributes associated with the recipe. In some implementations, a user (e.g., via WR process 10) may use a pointing device (e.g., cursor 402) to select a particular recipe to view. In some implementations, the name may be a URL (or other linking object), where selecting the recipe name may cause WR process 10 to access and display the full recipe (e.g., ingredients, instructions, etc.) to be made by, e.g., the prepared foods division of Company K. In some implementations, hovering cursor 402 over a recipe name may (e.g., via a pop-up window) display more details about the recipe (e.g., ingredients, instructions, attribute scores, etc.).

In some implementations, the list shown in user interface 400 may be automatically generated and transmitted to a user, e.g., based upon identification 300 of the above-noted product and/or a threshold amount of the identified 300 product determined by WR process 10 to have a likelihood of being wasted. In some implementations, user interface 400 may be transmitted via text, email, or other communication technique. In some implementations, the list shown in user interface 400 may be manually generated and/or transmitted to a user. In some implementations, once a recipe is selected, Company K (e.g., via WR process 10) may manually and/or automatically generate advertisements for the recipe, which may help generate more traffic to the recipe, which may increase in the chance for a consumer to purchase the end result of the recipe to limit the amount of the identified 300 product that may be wasted. It will be appreciated that other ways of alerting and/or displaying user interface 400 may be used without departing from the scope of the disclosure.

The terminology used herein is for the purpose of describing particular implementations only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps (not necessarily in a particular order), operations, elements, and/or components, but do not preclude the presence or addition of one or more other features, integers, steps (not necessarily in a particular order), operations, elements, components, and/or groups thereof.

The corresponding structures, materials, acts, and equivalents (e.g., of all means or step plus function elements) that may be in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications, variations, substitutions, and any combinations thereof will be apparent to those of ordinary skill in the art without departing from the scope and spirit of the disclosure. The implementation(s) were chosen and described in order to explain the principles of the disclosure and the practical application, and to enable others of ordinary skill in the art to understand the disclosure for various implementation(s) with various modifications and/or any combinations of implementation(s) as are suited to the particular use contemplated.

Having thus described the disclosure of the present application in detail and by reference to implementation(s) thereof, it will be apparent that modifications, variations, and any combinations of implementation(s) (including any modifications, variations, substitutions, and combinations thereof) are possible without departing from the scope of the disclosure defined in the appended claims.

1-7. (canceled)

8. A computer program product residing on a computer readable storage medium having a plurality of instructions stored thereon which, when executed by a processor, cause the processor to perform operations comprising:
identifying that a product of a plurality of products has a likelihood of being wasted;
identifying a recipe of a plurality of recipes that includes the product;
scoring one or more attributes of the recipe;
assigning a rating to the recipe based upon, at least in part, the one or more attributes of the recipe; and
returning the recipe as a suggestion to use the product before the product is wasted based upon, at least in part, the rating assigned to the recipe.

9. The computer program product of claim 8 wherein identifying that the product has the likelihood of being wasted includes analyzing an inventory listing the product as an available product, an expiration date of the product, and sales data associated with the product.

10. The computer program product of claim 8 wherein a product salvage scorer is used to score at least one of the one or more attributes.

11. The computer program product of claim 8 wherein a shelf life scorer is used to score at least one of the one or more attributes.

12. The computer program product of claim 11 wherein a score from the shelf life scorer is based upon, at least in part, ingredient-cooking verb pairs associated with the recipe.

13. The computer program product of claim 11 wherein a score from the shelf life scorer is based upon, at least in part, machine learning algorithm trained on a corpus of recipes labeled with shelf life scores.

14. The computer program product of claim 8 wherein a demand scorer is used to score at least one of the one or more attributes.

15. A computing system including a processor and a memory configured to perform operations comprising:
identifying that a product of a plurality of products has a likelihood of being wasted;
identifying a recipe of a plurality of recipes that includes the product;
scoring one or more attributes of the recipe;
assigning a rating to the recipe based upon, at least in part, the one or more attributes of the recipe; and
returning the recipe as a suggestion to use the product before the product is wasted based upon, at least in part, the rating assigned to the recipe.

16. The computing system of claim 15 wherein identifying that the product has the likelihood of being wasted includes analyzing an inventory listing the product as an available product, an expiration date of the product, and sales data associated with the product.

17. The computing system of claim 15 wherein a product salvage scorer is used to score at least one of the one or more attributes.

18. The computing system of claim 15 wherein a shelf life scorer is used to score at least one of the one or more attributes.

19. The computing system of claim 18 wherein a score from the shelf life scorer is based upon, at least in part, ingredient-cooking verb pairs associated with the recipe.

20. The computing system of claim 15 wherein a demand scorer is used to score at least one of the one or more attributes.
